(19) United States
(12) Patent Application Publication
(10) Pub. No.: US 2021/0059140 A1
(43) Pub. Date: Mar. 4, 2021

(54) HYDROPONIC GROW SYSTEM

(71) Applicant: Green Line Holdings LLC, Philadelphia, PA (US)

(72) Inventors: Arthur S. McHenry, III, Glen Mills, PA (US); T.J. Walton, Wilmington, DE (US); Timothy Ersek, Philadelphia, PA (US); Leon Weingrad, Philadelphia, PA (US)

(21) Appl. No.: 16/845,358

(22) Filed: Apr. 10, 2020

Related U.S. Application Data
(60) Provisional application No. 62/833,214, filed on Apr. 12, 2019.
(60) Provisional application No. 62/846,922, filed on May 13, 2019.
(60) Provisional application No. 62/875,705, filed on Jul. 18, 2019.
(60) Provisional application No. 62/975,926, filed on Feb. 13, 2020.
(60) Provisional application No. 62/980,607, filed on Feb. 24, 2020.
(60) Provisional application No. 62/984,005, filed on Mar. 2, 2020.
(60) Provisional application No. 62/984,134, filed on Mar. 2, 2020.

(51) Int. Cl. A01G 31/06; A01G 31/04; A01G 9/24

(52) U.S. Cl. CPC A01G 31/06; A01G 2031/006; A01G 9/249; A01G 31/04

(57) ABSTRACT

A hydroponic grow system is provided. The system includes at least one rack that holds one or more trays. Each tray includes an inlet and an outlet through which the tray receives a nutrient solution and returns the nutrient solution to a reservoir. The inlet and outlet of each tray is connected to the reservoir using connectors that can be easily removed or attached to the tray. This allows each tray to be easily removed from the rack for purposes of harvesting and cleaning. In addition, the grow system may include one or more conveyor tables that allow the trays to be easily transported from the racks to another location for harvesting.

### CROSS-REFERENCE TO RELATED APPLICATIONS

This application claims the benefit of priority to U.S. Provisional Patent Application No. 62/833,214 filed on Apr. 12, 2019, entitled “HYDROPONIC PRODUCTION LINE,” the contents of which are hereby incorporated by reference in its entirety. This application further claims the benefit of priority to U.S. Provisional Patent Application No. 62/846,922 filed on May 13, 2019, entitled “HYDROPONIC PRODUCTION LINE WITH ELIMINATED PLUMBING,” the contents of which are hereby incorporated by reference in its entirety. This application further claims the benefit of priority to U.S. Provisional Patent Application No. 62/875,705 filed on Jul. 18, 2019, entitled “FARM FACTORY,” the contents of which are hereby incorporated by reference in its entirety. This application further claims the benefit of priority to U.S. Provisional Patent Application No. 62/975,926 filed on Feb. 13, 2020, entitled “NUTRIENT SOLUTION,” the contents of which are hereby incorporated by reference in its entirety. This application further claims the benefit of priority to U.S. Provisional Patent Application No. 62/980,607 filed on Feb. 24, 2020, entitled “HEMP GROW TRAY SYSTEM,” the contents of which are hereby incorporated by reference in its entirety. This application further claims the benefit of priority to U.S. Provisional Patent Application No. 62/984,005 filed on Mar. 2, 2020, entitled “HYDROPONIC OXYGENATION SYSTEMS AND METHODS,” the contents of which are hereby incorporated by reference in its entirety. This application further claims the benefit of priority to U.S. Provisional Patent Application No. 62/984,134 filed on Mar. 2, 2020, entitled “HYDROPONIC GROW SYSTEM,” the contents of which are hereby incorporated by reference in its entirety.

### BACKGROUND

Hydroponic grow systems are used to grow a variety plants indoors including tomatoes, lettuce, and hemp. Typically, the grow systems include multiple trays or pots that are each individually connected to a one or more irrigation system. This requires many separate connections between main reservoir grow trays or pots in which the individual plants are grown.

While this may be an effective way in which to irrigate and fertigate, these types of systems are extremely labor intensive to plant, cultivate, harvest, and maintain. Rather than having trays delivered to specialized areas with fewer specialized production line type employees, most hydroponics systems use fixed trays. Because fixed trays are permanently plumbed within the cultivation area, they require employees to plant, harvest, and clean the trays within the cultivation area, and spending valuable time going in and out of the cultivation space and going up and down scissor lifts to get to the top trays.

### SUMMARY

A hydroponic grow system is provided. The system includes at least one rack that holds one or more trays. Each tray includes an inlet and an outlet through which the tray receives a nutrient solution and returns the nutrient solution to a reservoir. The inlet and outlet of each tray is connected to the reservoir using connectors that can be easily removed or attached to the tray. This allows each tray to be easily removed from the rack for purposes of harvesting and cleaning. In addition, the grow system may include one or more conveyor tables that allow the trays to be easily transported from the racks to another location for harvesting.

As may be appreciated, the grow system described herein provides many advantages over the prior art. First, because the trays are attached to the reservoir system using removable connectors, the trays can be removed from the racks for purposes of harvesting, cleaning, and replanting. After the trays have been removed, they can be harvested, cleaned, and replanted within one day to start a new grow cycle thereby increasing the yield of the grow system. Furthermore, because the trays are moved through the grow system using one or more conveyor tables, the amount of labor needed to operate the grow system is reduced.

In an embodiment, a grow tray system is provided that includes a grow tray and an insert that is placed inside of the grow tray. The insert may have a series of legs that keeps the surface of the insert level with the top of the grow tray when the insert is placed in the grow tray. The insert further includes a series of openings that are each adapted to receive a growth medium such as rockwool. The legs of the insert are sized such that the bottom of each growth medium is allowed to touch the surface of a nutrient solution placed in the grow tray. Because the growth mediums are not completely submerged, air is able to circulate around the growth mediums below the surface of the insert. This allows the roots of the plants placed in each growth medium to receive nutrients through the portions of the growth medium that are in contact with the nutrient solution while the roots are aerated through the portions of the growth medium that are not in contact with the nutrient solution.

A hydroponic nutrient solution for hydroponically growing plants is provided. The solution includes water, nitrate, ammonium, phosphorus, potassium, calcium, and magnesium. The solution may further include iron, manganese, boron, copper, zinc, molybdenum, sodium, nickel, aluminum, silicon, and sulfur.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is an illustration of an example grow system;

FIG. 2 is an illustration of a top view of an example grow system;

FIG. 3 is an illustration of a side view of a grow system;

FIG. 4 is an illustration of an example removable connector to use with an inlet or outlet of a tray;

FIG. 5 is an illustration of an example tray placed in a rack;

FIG. 6 is an illustration of an example reservoir;

FIG. 7 is an illustration of a plurality of trays placed in a rack;

FIG. 8 is an illustration of a plurality of trays placed in a rack;

FIG. 9 is an illustration of a plurality of trays placed in a rack;

FIG. 10 is a perspective view of an example grow tray system;

FIG. 11 is an illustration of a side view of an example grow tray system;

FIG. 12 is an illustration of a side view of an example grow tray system that includes one or more growth mediums;

FIG. 13 is an illustration of a view of an example grow tray system that includes a growth medium;

FIG. 14 is an illustration of a view of an example grow tray system that includes a growth medium;

FIG. 15 is an illustration of another view of an example grow tray system that includes a growth medium;

FIG. 16A is an illustration of a side view of an example locking device for use with the grow tray system;

FIG. 16B is an illustration of a perspective view of an example locking device for use with the grow tray system;

FIG. 16C is an illustration of a side view of an example locking device connecting a pair of grow trays;

FIG. 17 is an illustration of an example grow tray with locking components;

FIG. 18 is an illustration of an example grow tray system that includes an insert with safety guards;

FIG. 19 is an illustration of an example tank for oxygenating water with or without a nutrient solution; and

FIG. 20 is an illustration of an example hydroponic grow system.

### DETAILED DESCRIPTION

### I. Grow System Overview

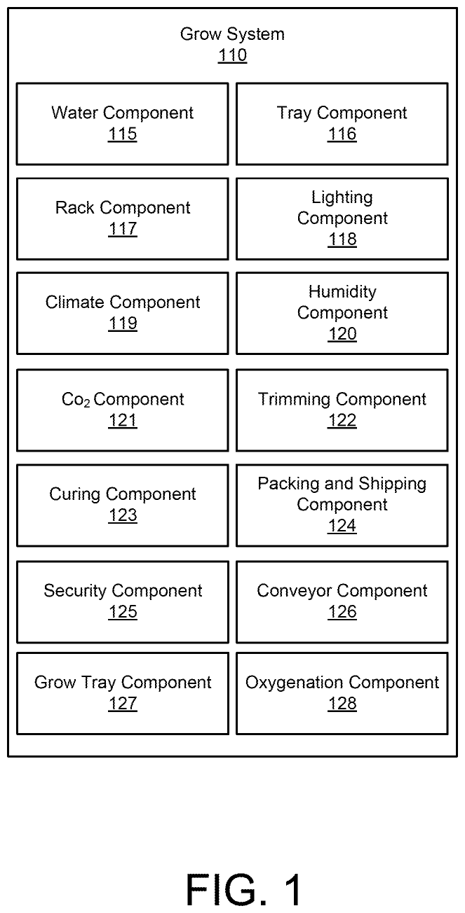

FIG. 1 is an illustration of an example grow system 110. As shown, the grow system 110 includes several components including, but not limited to, a water component 115, a tray component 116, a rack component 117, a lighting component 118, a climate component 119, a humidity component 120, a CO₂ component 121, a trimming component 122, a curing component 123, a packing and shipping component 124, a security component 125, a conveyor component 126, a grow tray component 127, and an oxygenation component 128. More or fewer components may be supported by the grow system 110.

The water component 115 may circulate the nutrient solution through the grow system 110. The water component 115 may include a reservoir that stores the nutrient solution. The reservoir may receive water for the nutrient solution from a filter such as a reverse osmosis filter. Other types of filters may be used. A suitable reservoir may be the Plastic-Mart TC3000IW and may be at least 500 gallons. Other reservoirs may be used. Note that multiple reservoirs may be used.

The water component 115 may circulate the nutrient solution through a plurality of pipes or tubes that are attached to one or more trays of the tray component 116. The nutrient solution may be added to the reservoir using a pump and may rely on gravity to move the solution through the one or more trays of the tray component 116 to a return tank. The water component 115 may further include one or more additional pumps that returns the nutrient solution to the reservoir from the return tank after it has passed though the trays of the tray component 116. Any type of pump may be used. Depending on the embodiment, the nutrient solution may be circulated at a rate of at least one time per hour.

The water component 115 may further include a chiller that keeps the temperature of the nutrient solution within a desired temperature range of 67 to 69 degrees Fahrenheit. A suitable chiller includes the Multi-Aqua High Efficiency Air Cooled Chiller. Other types of chillers may be used.

The water component 115 may further include a pH regulation system that keeps the pH of the nutrient solution within a range of 67-69 degrees Fahrenheit. Any method for pH regulation may be used.

The tray component 116 may include a series of trays that are adapted to receive the nutrient solution from the water component 115. A suitable tray is the Botanicare 4×4 tray. Other trays and tray sizes may be used.

Each tray may further include an inlet port and an outlet port. The inlet port may receive nutrient solution from the water component 115 and the outlet port may return nutrient solution back to the water component 115 (or the inlet port of another tray). The inlet and outlet ports may be approximately ½ inch in diameter. The inlet and outlet ports may be connected to the water component 115 using removeable connectors that allow a technician to quickly and easily disconnect the tray from the water component 115 (or other trays) for purposes of removing the tray or draining the tray. As described further below, this may allow the tray to be easily removed for purposes of harvesting, cleaning, and replanting. Further, the pipes and tubes can be disconnected for cleaning. Suitable removeable connectors include Banjo PVC connectors or a union of connectors. Other types of connectors/disconnectors may be used.

The rack component 117 may include one or more levels with each level able to hold one or more trays of the tray component 116. The racks may be designed to allow a technician to easily and quickly remove trays with plants that are ready for harvesting and efficiently clean, replant and return the trays to the rock quickly. Depending on the embodiment, each rack may be approximately 60 inches×144 inches×108 inches.

Depending on the embodiment, each rack may include a conveyance means, such as rollers or ball bearings, integrated into the surfaces of the rack that support the trays. This may allow a technician to easily side a tray off of the rack and onto the conveyor component 126 as described below. Alternatively, or additionally, wheels may be attached to the bottom of each tray allowing the trays to move along the surface of each rack. In addition, racks may include removable sides to corral plants while harvesting.

The lighting component 118 may provide light to each plant growing in a tray of the tray component 116 using a plurality of lights. Depending on the embodiment, each light may attach to the rack component 117 such that the light illuminates a corresponding tray. The distance between each light and its corresponding tray may be adjustable, or the fixture can be dimmable. A suitable light includes the SPYDR 2P Fluence Lights. Other types of lights may be used. Suitable lights may emit between 200 and 1300 μmoles.

The climate component 119 may ensure that the temperature of the grow system 110 remains within optimal growth ranges. The temperature of the grow system 110 may be adjusted such that the leaf temperature of the plants in the grow system 110 is between 65 and 78 degrees Fahrenheit.

The humidity component 120 may ensure that the humidity of the grow system 110 remains within optimal growth ranges. The humidity component 120 may include both a humidifier and a dehumidifier to control the humidity. Suitable humidifiers include the Dristeem XTP-10 and XTP-06. Suitable dehumidifiers include the Quest 105. Other humidifiers and dehumidifiers may be used. A suitable humidity range is between 50 and 70.

The CO₂ component 121 may ensure that the plants in the grow room receive an optimal amount of carbon dioxide while growing. Any suitable system for providing carbon dioxide may be used. A suitable CO₂ concentration is between 800 and 1500 ppm.

The trimming component 122 may be used to trim the plants in the grow system 110 after they have been harvested. A suitable trimmer/bucker includes the Green Broz 1517 Model M. Other trimmers may be used.

The curing component 123 may be used to dry and cure the plants after they have been trimmed. Depending on the embodiment, the curing component 123 may use a dryer such as the Biologics modular drying system. The curing component 123 may further use a curer such as the Cure Advantage curing system. Other curing systems may be used.

The packing and shipping component 124 may be used to pack and ship the cured and dried plants. Any method or system for packing and shipping may be used.

The security component 125 may provide security to the grow system 110 and the contents of the grow system 110. The security component 125 may include cameras, locks, alarms, motion sensors, smoke detectors, and any other features or devices that are commonly used to provide security to hydroponic grow systems.

The conveyor component 126 may allow trays and other items to be easily, quickly, and efficiently moved through the various components of the grow system 110. In some implementations, the conveyor component 126 may include a conveyor table or a conveyor belt or rollers/castors and a conveyor elevator that extends from at least the rack component 117 to the trimming component 122. The rack may further include side walls that can be removed to move the trays to the conveyor component 126.

The grow tray component 127 may include grow trays that is placed in each tray. Each grow tray includes openings that receive and supports plants growing in a growing medium such as rockwool. A suitable grow tray is described below.

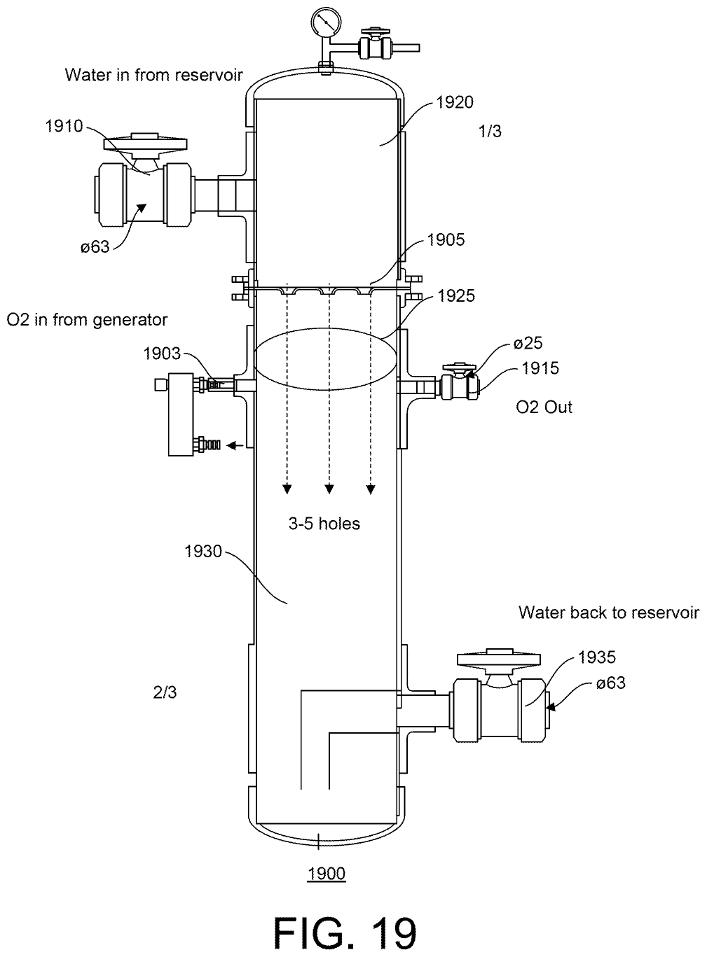

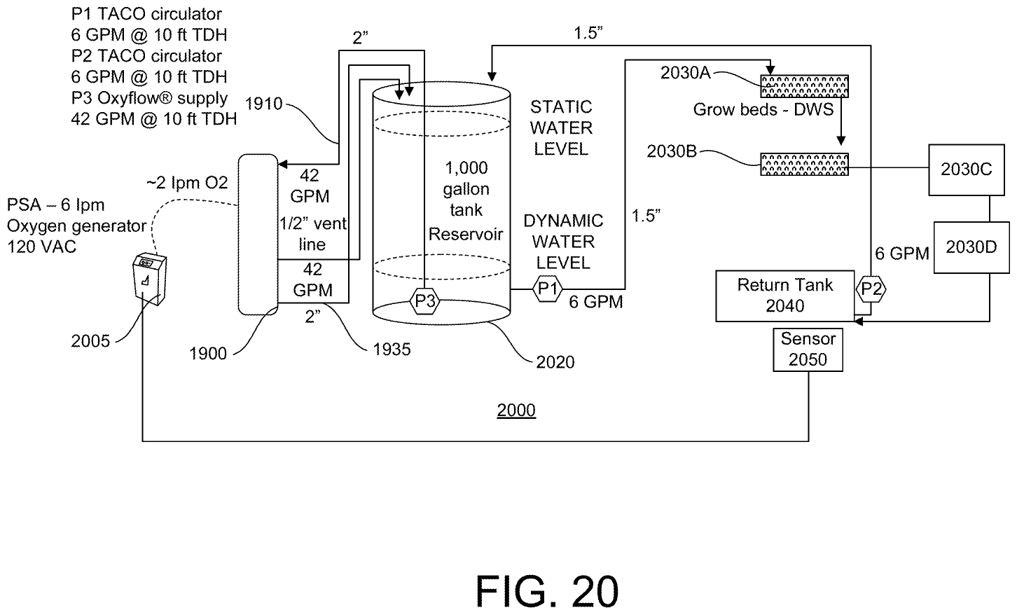

The oxygenation component 128 may further include an oxygenation system. A suitable oxygenation system is described below with respect to FIGS. 19 and 20. The oxygenation component 128 may maintain dissolved oxygen levels of between 10 and 20 ppm.

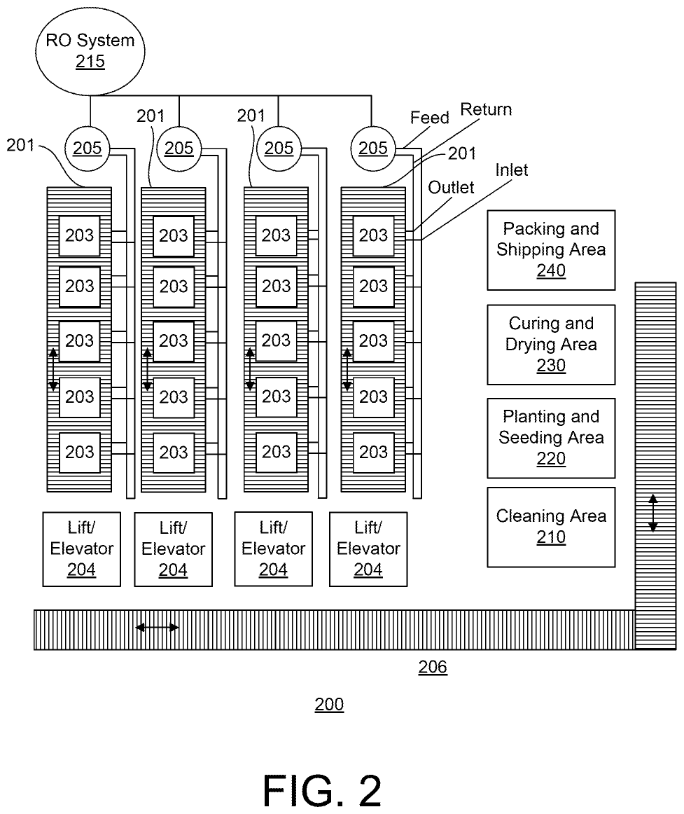

FIG. 2 is an illustration of a top view of a grow system 200 incorporating many of the components of the grow system 110 described in FIG. 1. In the example shown, the grow system 200 includes a plurality of racks 201 each supporting a plurality of trays 203. The racks 201 may be part of the rack component 117 and the trays 203 may be part of the tray component 116. Note the number of racks 201 and the number of trays 203 on each rack 201 is for illustrative purposes only. More or fewer racks 201 and trays 203 may be supported. In addition, each rack 201 may have multiple levels that each can support multiple trays 203.

Each rack 201 is associated with a reservoir 205 that circulates water that contains a nutrient solution to the trays 203 located on the rack 201. The water may be received from a reverse osmosis system 215. Water with the dissolved nutrient solution may be referred to herein as nutrient solution. The reservoirs 205 may be part of the water component 115 described above. Each reservoir 205 may provide the nutrient solution to a tray 203 through the feed line, input line, or bulkhead. The feed line may be gravity fed and may connect to each tray 203 through an inlet associated with each tray 203. Each reservoir 205 may receive the used nutrient solution from the trays 203 through the return line from a return tank. The return line may use a pump to return the nutrient solution to the associated reservoir 205 and may connect to each tray 203 through the outlet associated with each tray 203.

The outlet and inlet associated with each tray 203 may be connected to the feed line and return line using a removable connector. This may allow each tray 203 to be easily disconnected for purposes of plant harvesting cleaning and replanting.

While not shown, each rack 201 may include a plurality of lights that provide light to the plants growing in each tray 203. The lights may be part of the lighting component 118.

When a tray 203 is removed from a rack 201 (and disconnected from the feed line and return line), the tray 203 may be moved on the conveyor 206. The conveyor 206 may be a roller conveyor and may allow the trays 203 to easily and quickly moved from the racks 201 to a cleaning area 210. After being harvested, depending on the embodiment, each rack 201 may include one or more rollers underneath the trays 203 such that the trays 203 can be easily rolled from the rack 201 to the conveyor 206. The conveyor 206 may be part of the conveyor component 126.

Each rack may further be associated with a lift/elevator 204. The lift/elevator 204 may allow trays 203 to be easily removed from a level of the rack 201 and placed onto the conveyor 206. The lift/elevator 204 may further allow trays 203 to be easily placed onto the levels of the rack 201 from the conveyor 206.

The cleaning area 210 may be where the trays 203 are taken after they are removed from the racks 201 and harvested. In some embodiments, in the cleaning area 210 each tray 203 may be cleaned to remove any residue or other materials caused by the nutrient solution. In addition, some or all of the plants removed from each tray 203 may be trimmed to separate the valuable plant materials from the non-valuable plant materials. The trimming may be performed by the trimming component 122.

After each tray 203 has been cleaned, it may be move to the planting and seeding area 220. In the planting and seeding area 220, clones may be propagated and grown to seedlings. Some or all of the clones may be placed in a grow medium such as rockwool and placed into the cleaned and emptied trays 203. Once each tray 203 has received new plants, the trays 203 may be placed back on the conveyor 206 and returned to the racks 201 where another grow may begin.

After the plants have been trimmed in the cleaning area 210, the plants may move to the curing and drying area 230. The plants may be cured and dried using a variety of well-known curing and drying techniques. The curing and drying may be performed by the curing component 123.

Finally, after the plants have been cured and dried, they may move to the packing and shipping area 240 where the plants are packed and prepared for shipment to customers. The packing and shipping may be performed by the packing and shipping component 124.

Note that many of the components of the grow system 110, while not illustrated in the grow system 210, may be part of the grow system 200. For example, the CO₂ may be controlled by a CO₂ burner associated with the CO₂ component 121, the humidity of the grow system 200 may be controlled by the humidity component 120, and the contents of the grow system 200 may be secured using security measures associated with the security component 125.

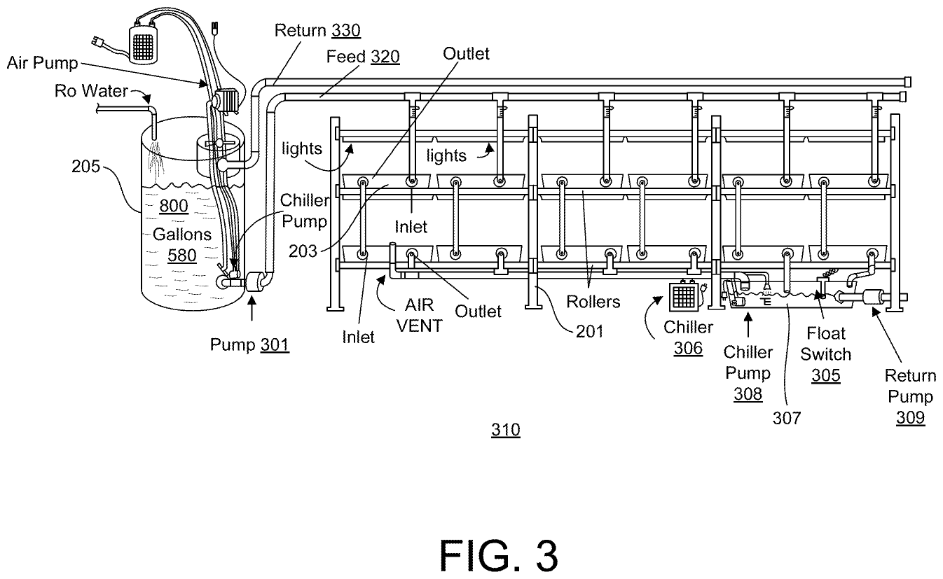

FIG. 3 is an illustration of a side view of a grow system 310 incorporating many of the components of the grow system 110 described in FIG. 1. The grow system 310 includes a reservoir 205 that holds a nutrient solution. The reservoir 205 receives water for the nutrient solution from a reverse osmosis filter. Other types of filters may be used. The grow system 310 may include an oxygenation system that may keep the level of dissolved oxygen in the nutrient solution between approximately 10.0 and 20.0 ppm.

The grow system 310 further includes a rack 201 that holds a plurality of trays 203. In the example shown, there are two levels of trays 203. More or fewer levels of trays 203 may be used.

The reservoir 205 further includes a pump 301 that pumps the nutrient solution into a feed line 320. The feed line 320 may be a pipe that uses gravity to distribute the nutrient solution to the trays 203. In the example shown, each tray 203 of the top level of the rack 201 may connect to the feed line 320 through an inlet. An outlet of each tray 203 of the top level of the rack 201 may connect to an inlet of a tray 203 of the bottom level of the rack 201. Each tray 203 of the bottom level may connect to a return tank 307 though an outlet. The return tank 307 may include a float switch 305 that causes a return pump 309 to activate when the nutrient solution reaches a threshold level. The return pump 309 may cause the nutrient solution in the return tank 307 to be pumped back to the reservoir 205 via the return line 330. The rack 201 may further include rollers or castors on each level to move the trays 203.

In addition, the return tank 307 may further be connected to a chiller 306 that reduces the temperature of the nutrient solution before it is returned to the reservoir 205. The chiller 306 may receive the nutrient solution from the return tank 307 via a chiller pump 308.

Note that the inlets and outlets of each tray 203 are connected using removable connectors such as Banjo PVC connectors. This may allow individual trays 203 to be isolated and removed from the rack 201 while the remaining trays 203 continue to receive nutrient solution. This is an improvement over prior art systems where trays 203 are either difficult to remove or require that the entire nutrient solution delivery system to be stopped to remove a single tray 203.

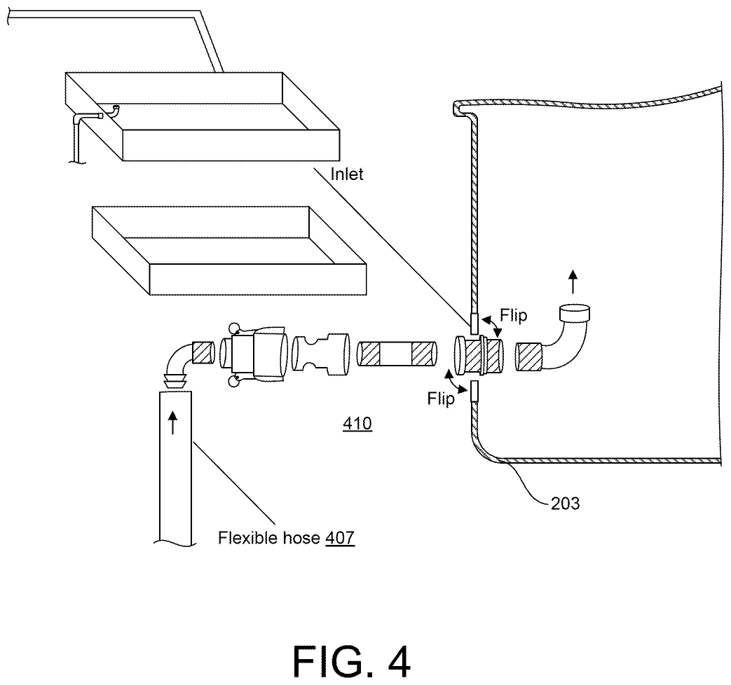

FIG. 4 is an illustration of an example removable connector 410 to use with an inlet or outlet of a tray 203. In the example shown, the removeable connector 410 is shown in an expanded view so that the various components of the removeable connector 410 can be seen. The removeable connector 410 may connect to the inlet of the tray 203 on one end and may attach to a flexible hose 407 on the other end. The flexible hose 407 may attach to the feed line 320 of the reservoir 205 via a valve and may provide nutrient solution to the tray 203 via the removeable connector 410.

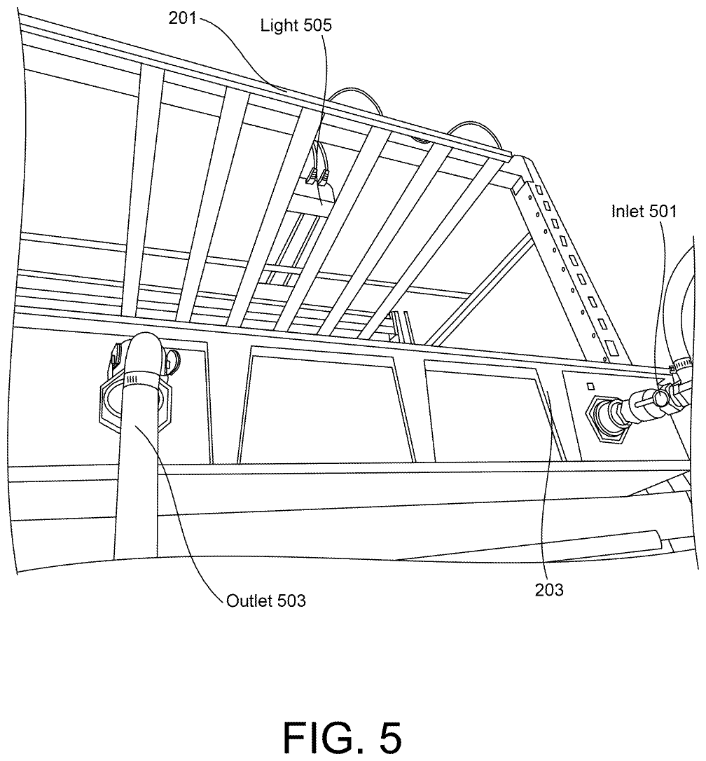

FIG. 5 is an illustration of an example tray 203 placed in a rack 201. Visible in the illustration is an inlet 501, an outlet 503, and a light 505. The tray 203 may receive the nutrient solution through the inlet 501 and may provide excess nutrient solution though the outlet 503. As can be seen in the illustration, both of the inlet 501 and the outlet 503 use removable quick release connectors so the tray 203 can be quickly and easily removed from the rack 201.

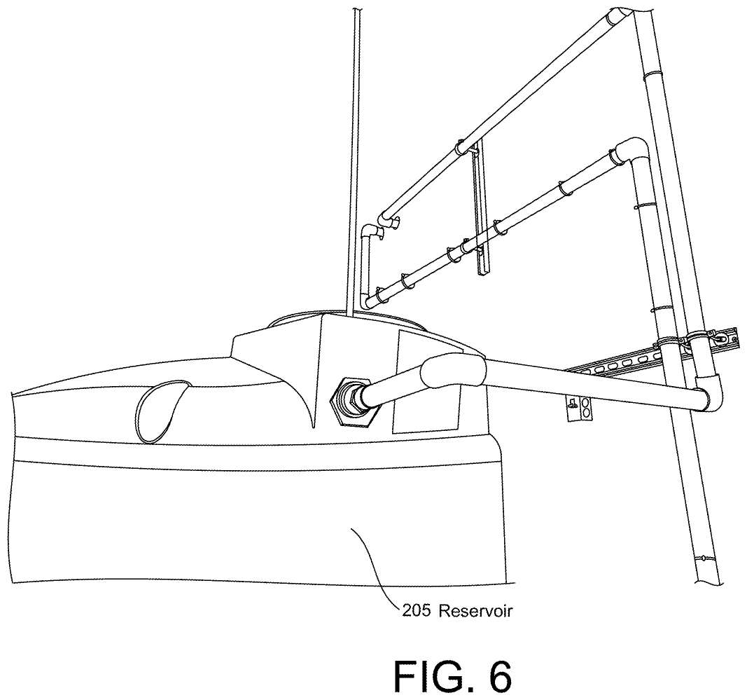

FIG. 6 is an illustration of an example reservoir 205. The reservoir 205 provides nutrient solution to one or more trays of a rack.

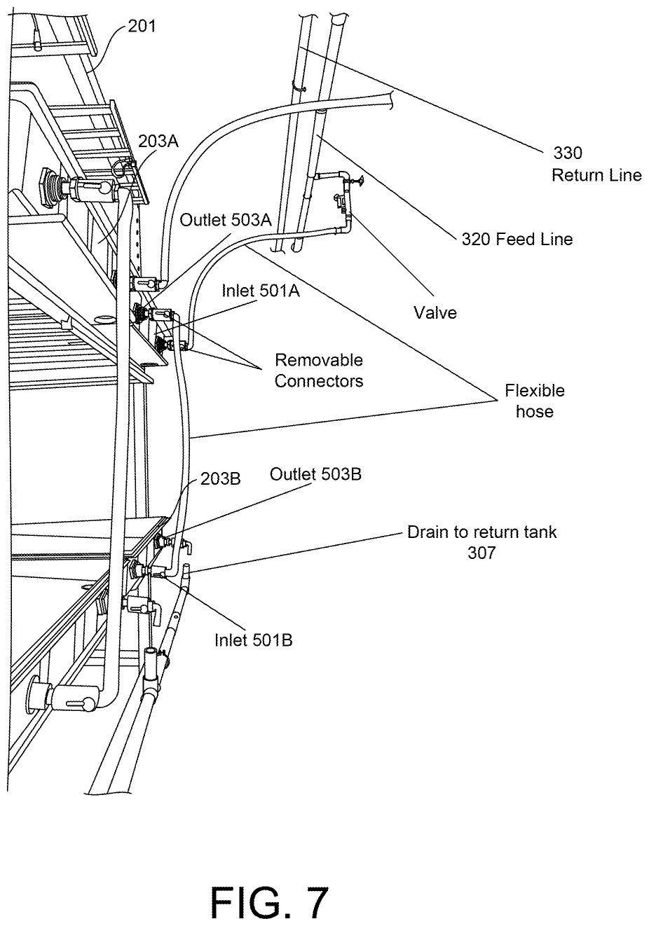

FIG. 7 is an illustration of a plurality of trays 203 (i.e., the trays 203A and 203B) placed in a rack 210. Visible in the image is the feed line 320 that provides nutrient solution from the reservoir 205 to the tray 203A, and the return line 330 that returns the nutrient solution from the return tank 307 to the reservoir 205. Also shown is a valve that connects to the feed line 320 through a flexible hose. The flexible hose connects to an inlet 501A of a tray 203A on the top level of the rack 201 via a removeable connector.

The outlet 503A of the tray 203A on the top level of the rack 201 connects to an inlet 501B of the tray 203B on the bottom level of the rack 201 through a pair of removable connectors and another flexible hose. An outlet 503B of the tray 203B on the bottom level of the rack 201 is connected to a gravity fed drain that empties into the return tank 307.

As may be appreciated, when nutrient solution enters the feed line 320 it passes through the valve and into the inlet 501A of the tray 203A on the top level of the rack 201 via the flexible hose and the removable connectors. Once the tray 203A on the top level of the rack 201 is filled past the outlet 503A, the excess nutrient solution may begin to exit the tray 203A through the outlet 503A and may flow (by gravity) into the inlet 501B of the tray 203B on the bottom level of the rack 201 via the removeable connector and flexible hose. Once the tray 203B on the bottom level of the rack 201 is filled past the outlet 503B, the excess nutrient solution may begin to exit the tray 203B through the outlet 503B and may flow (by gravity) into the drain that connects to the return tank 307. The nutrient solution may then be pumped from the return tank 307 to the reservoir 205 via the return line 330.

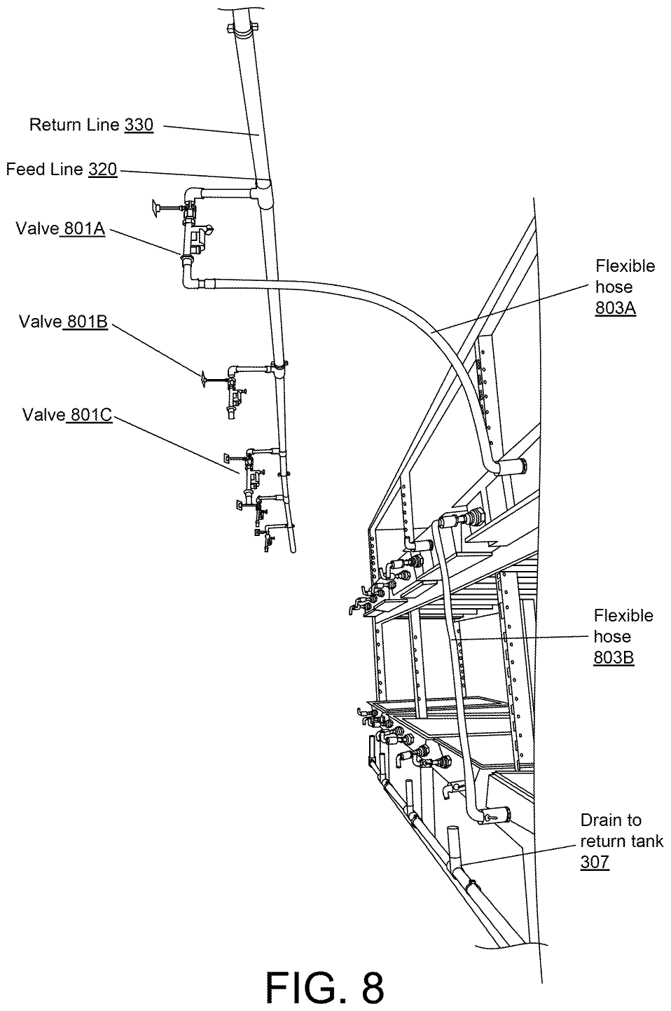

FIG. 8 is another illustration of a plurality of trays 203 placed in a rack 201. FIG. 8 shows how each pair of trays 203 comprising a tray 203 in the top level of the rack 201 and corresponding tray 203 on the bottom of the rack 201 receive nutrient solution from the feed line 320 via a different valve 801 (i.e., valves 801A-C) connected to a flexible hose 803 (i.e., flexible hoses 803A-C) through a removeable connector. This arrangement may allow for pairs of trays 203 to be easily removed from, or added to, the rack 201 without affecting other trays 203 in the rack 201.

For example, if user desires to remove a tray 203 of a pair of trays 203 for cleaning or harvesting, the user can close the valve 801 through which the topmost tray 203 receives nutrient solution from the feed line 320. The tray 203 of the pair of trays 203 may then be drained of nutrient solution through its outlet by disconnecting the removable connector. The drained tray 203 may be removed from the rack 201. Because the valves 801 used to provide nutrient solution to the other pair of trays 203 remain open, the remaining trays 203 may continue to receive nutrient solution while the selected tray 203 or trays 203 are removed.

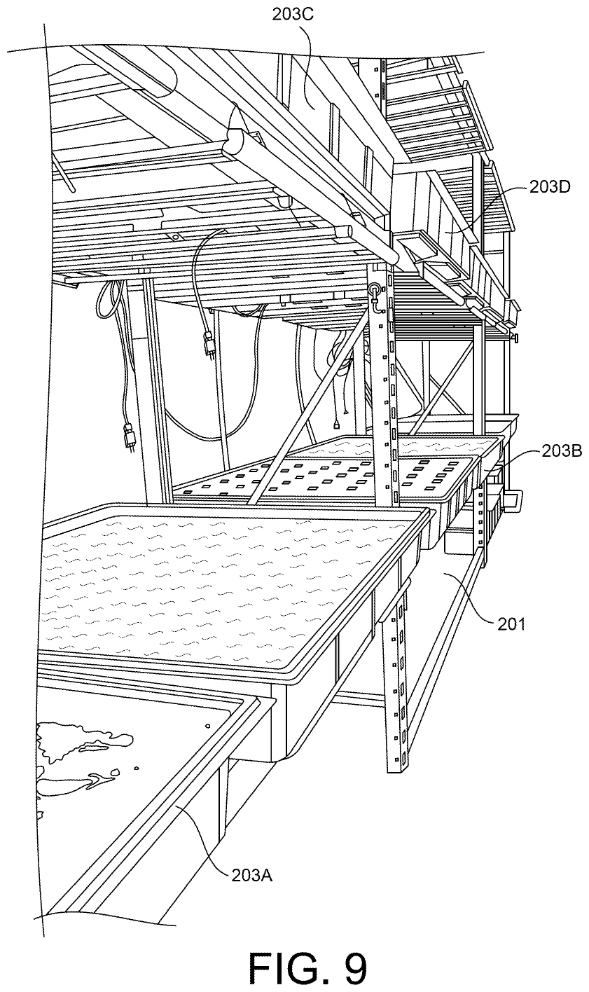

FIG. 9 is an illustration of a plurality of trays 203 (i.e., trays 203A-D) placed in a rack 201. Visible in the illustration are multiple trays 203 placed on two levels of the rack 201. Depending on the embodiment, the rack 201 may have more or fewer levels than shown in the image.

### II. Grow Tray

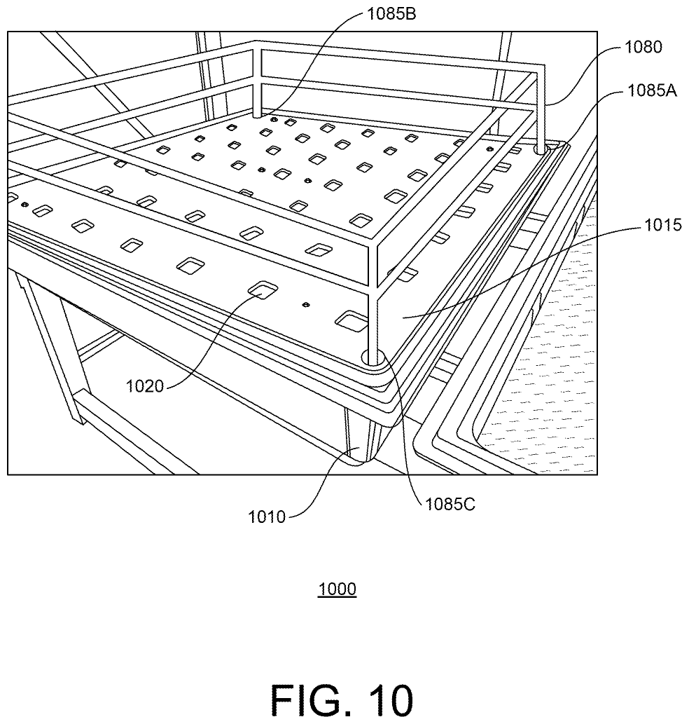

FIG. 10 is a perspective view of an example grow tray system 1000. In the example shown, the grow tray system 1000 includes a grow tray 1010. The grow tray 1010 may be approximately 48 inches in length and width to 55 inches in length and width. The grow tray 1010 may be approximately 3 to 15 inches deep. However, other sized grow trays 1010 may be used.

The grow tray system 1000 may further include an insert 1015 (also referred to as a board) that is placed inside of the grow tray 1010. As shown, the insert 1015 is a slightly smaller size than the top opening of the grow tray 1010. As described further, this may allow air to flow below the surface of the insert 1015 when it is placed inside of the grow tray 1010.

Depending on the embodiment, the insert 1015 may be constructed from a material such as plastic, glass, or fiberglass. However, other materials may be used. The insert 1015 may be approximately ¾ to 1 inch thick. The material may be non-porous and food-grade. The material may further be rigid and opaque.

While not visible in FIG. 10, the insert 1015 may have a series of leg or supports affixed to the underside of the insert 1015. The legs may be sized such that the topside of the insert 1015 is at approximately the same height as the top-most portion of the grow tray 1010 when the insert 1015 is placed in the grow tray 1010. In one embodiment, the legs are approximately ¼ inch to 1 inch in width and 4 inches to 15 inches in height. Other sized legs may be used. The legs may be made from a material such as plastic or metal. Other materials may be used.

The number of legs affixed to the underside of the support may be selected such that the insert 1015 is stable when placed in the grow tray 1010 and sufficient air is able to circulate between the legs. In one embodiment, there may be approximately eight to twelve legs. More or fewer legs may be used.

The insert 1015 may further include a plurality of openings 1020 on the top surface. Each opening 1020 may be adapted to receive a piece of growth medium such as rockwool. Other growth mediums may be used. In the example shown, there are 49 openings 1020. More or fewer openings 1020 may be used.

Each opening 1020 may be sized such that a portion of growth medium that is placed in the opening 1020 can pass through the opening 1020 while a remainder of the growth medium remains supported by the insert 1015. The growth medium may remain supported even as a plant grows from the growth medium. An example size of each opening 1020 is approximately ¾ inch to 1 inch, either round or square. Other sizes may be used depending on the type of plant being grown and the growth medium being used. An example plant includes hemp.

The openings 1020 may be spaced along the insert 1015 such that each plant growing in the growing mediums placed in the openings 1020 has sufficient space to grow. The optimal number and size of the openings 1020 may change depending on the cultivar or plant being grown. In addition, the openings 1020 may be spaced such that there is sufficient airflow between the portions of growth medium that pass through each opening 1020. In one embodiment, the openings 1020 may be spaced such that there is at least two inches between each opening 1020. Note that the number, size, and spacing of the openings 1020 may be dependent on factors such the types of plants being grown, and the growth medium being used.

The grow tray system 1000 may further include a screen-of-grass (“scrog”) structure 1080 or trellis system. In the example shown, the scrog structure 1080 includes four legs and has two horizontal levels. More or fewer levels may be supported. Each level may be adapted to receive a scrog netting that is stretched across the level (not shown). The scrog netting forms a barrier that helps limit the vertical growth of plants in the insert 1015 while encouraging horizontal growth. Depending on the embodiment, the scrog structure 1080 may be constructed of ½ inch PVC piping. Other materials may be used.

In the example shown, the insert 1015 includes holes 1085 (i.e., the holes 1085A-C) that are each adapted to receive a leg of the scrog structure 1080. The holes 1085 allow the scrog structure 1080 to be easily added to, and removed from, the insert 1015. The holes 1085 further provide stability to the scrog structure 1080 when it is placed in the insert 1015. The legs of the scrog structure 1080 may be sized such that each leg touches the bottom of the grow tray 1010 when placed in the insert 1015, while a sufficient amount of space is created between the first level of the scrog structure 1080 and the top surface of the insert 1015. Alternatively, each leg may be supported by a hole 1085 and a bottom of the insert 1015 and may not extend to the bottom of the grow tray 1010.

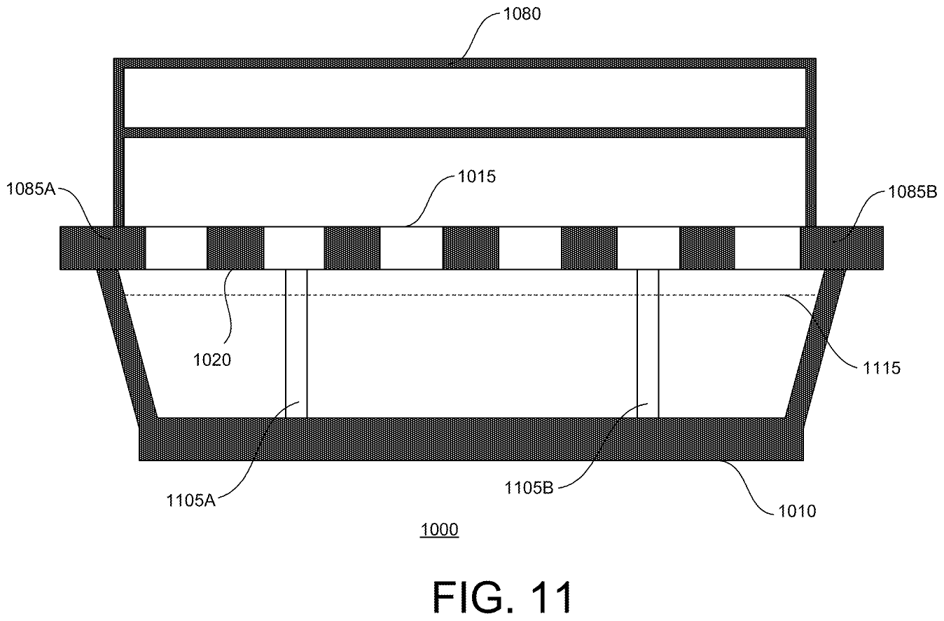

FIG. 11 is an illustration of a side view of an example grow tray system 1000. In the example shown, the grow tray system 1000 includes a grow tray 1010, an insert 1015, and a scrog structure 1080. The insert 1015 includes legs 1105 (i.e., the legs 1105A and 1105B) that support the insert 1015 when it is placed in the grow tray 1010. The insert 1015 further includes a series of openings 1020. The insert 1015 further includes a plurality of holes 1085 (i.e., the holes 1085A and B) that each receive a leg of the scrog structure 1080.

As described previously, the grow tray 1100 is adapted to receive and hold a nutrient solution. A water line 1115 illustrates the height of the nutrient solution when the grow tray 1010 is filled. The grow tray 1010 may be filled through one or more inlets and may be drained through one or more outlets.

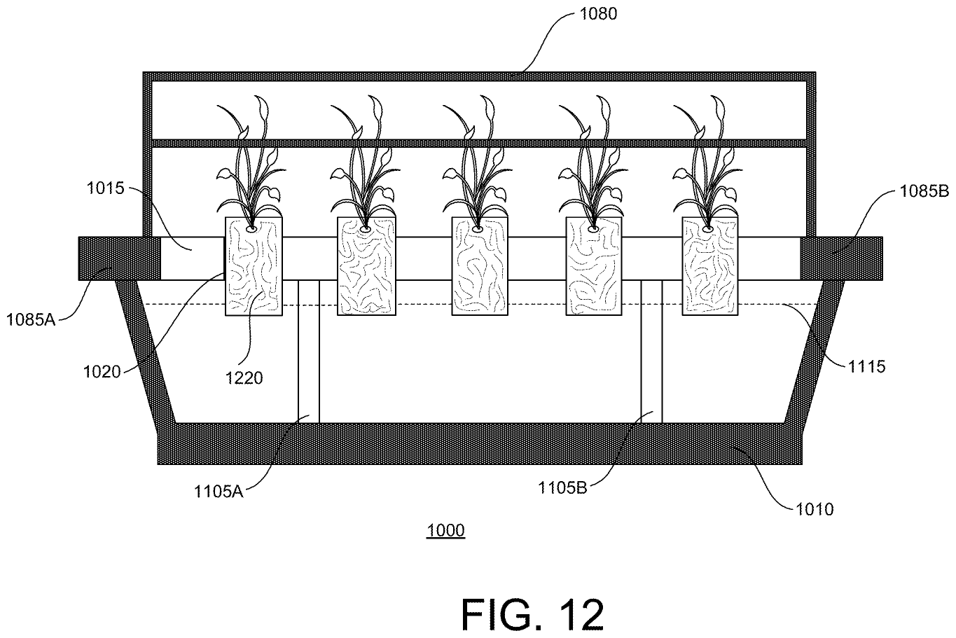

FIG. 12 is a side view of an example grow tray system 1000 that includes one or more growth mediums 1220. In particular, a growth medium 1220 has been placed in each of the openings 1020 of the insert 1015. As can be seen, each of the growth mediums 1220 is placed in an opening 1020 such that only a portion of each growth medium 1220 is in contact with the nutrient solution. The size of the portion that is contact with the nutrient solution may be adjusted by one or more of adjusting a length of the legs 1105 (i.e., the legs 1105A and 1105B), adjusting the depth of the nutrient solution, or adjusting the size of the growth mediums 1220.

As can be seen in FIG. 12, a space is formed between the water level 1115 and the bottom of the insert 1015. This space allows air to flow around each of the non-submerged portions of the growth mediums 1220. As a result, each plant growing in a respective growth medium 1220 is able to receive nutrients through the portions of the growth medium 1220 that are submerged in the nutrient solution while also being aerated through the portions of the growth medium 1220 that are exposed to the air that passes between the water line 1115 and the bottom of the insert 1015. In addition, a scrog netting across the first horizontal level of the scrog structure 1080 may limit the vertical growth of each plant and may encourage the plants to grow in the horizontal direction.

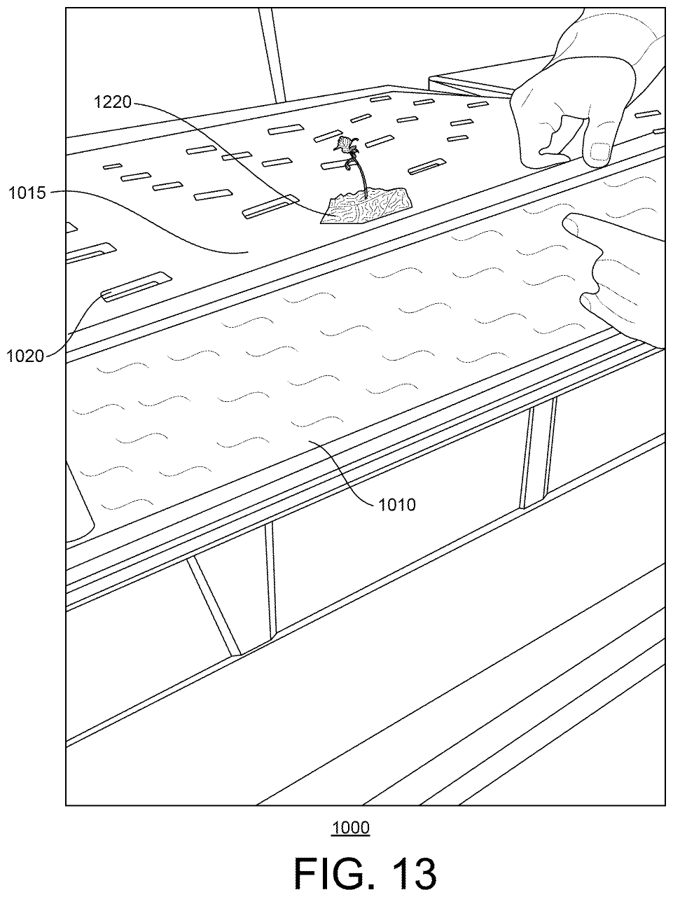

FIG. 13 is an illustration of another view of an example grow tray system 1000 that includes a growth medium 1220. In the example shown, the insert 1015 is being lifted up to show the nutrient solution in the grow tray 1010.

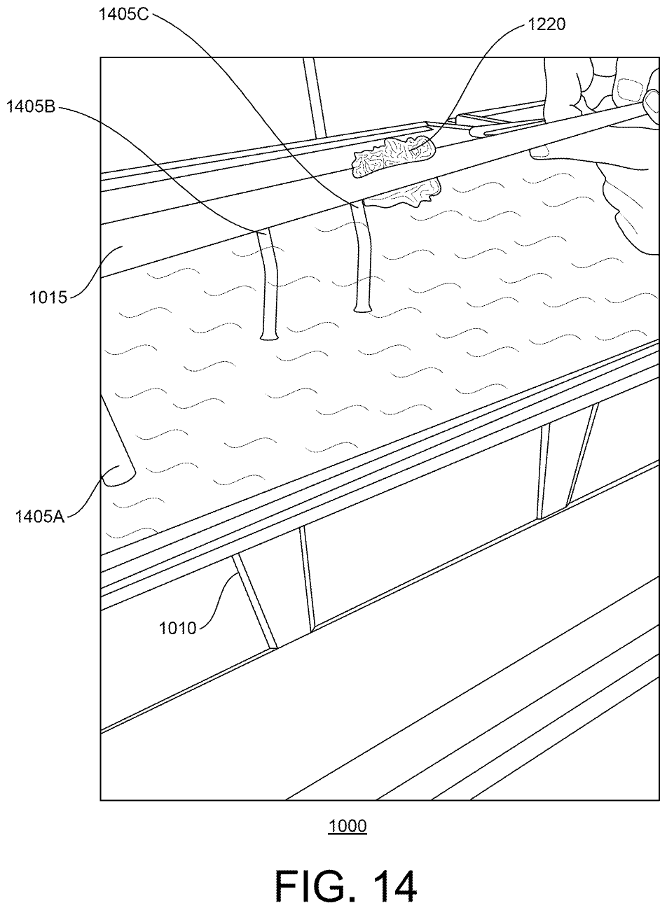

FIG. 14 is an illustration of another view of an example grow tray system 1000 that includes a growth medium 1220. In the example shown, the insert 1015 is being lifted up to show the nutrient solution in the grow tray 1010. In addition, several legs 1405 (i.e., the legs 1405A-C) are visible under the insert 1015. The portion of the growth medium 1220 that extends through an opening and into the nutrient solution is also visible.

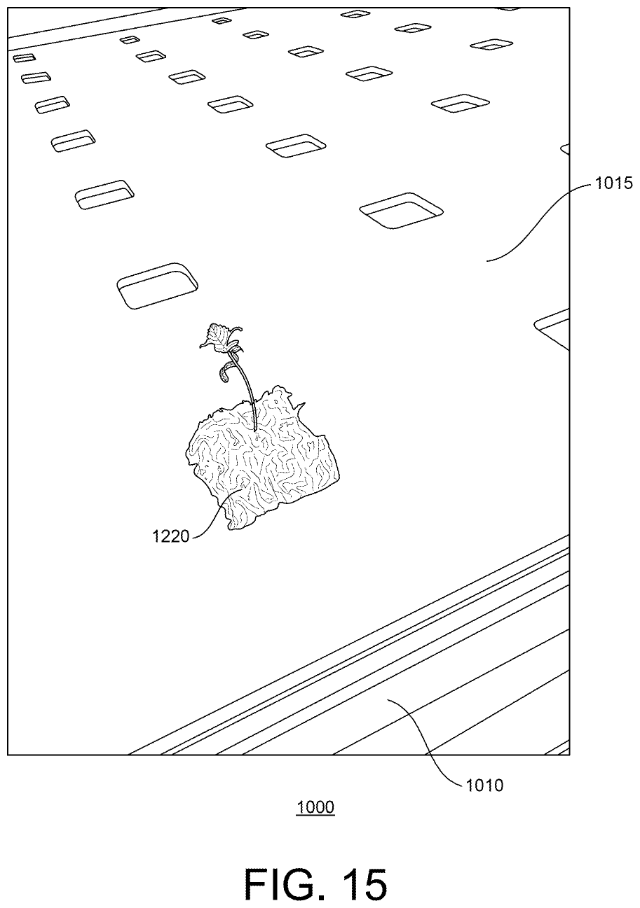

FIG. 15 is an illustration of another view of an example grow tray system 1000 that includes a growth medium 1220. In the example shown, the insert 1015 is resting in the grow tray 1010. A portion of the growth medium 1220 that extends above the insert 1015 is visible.

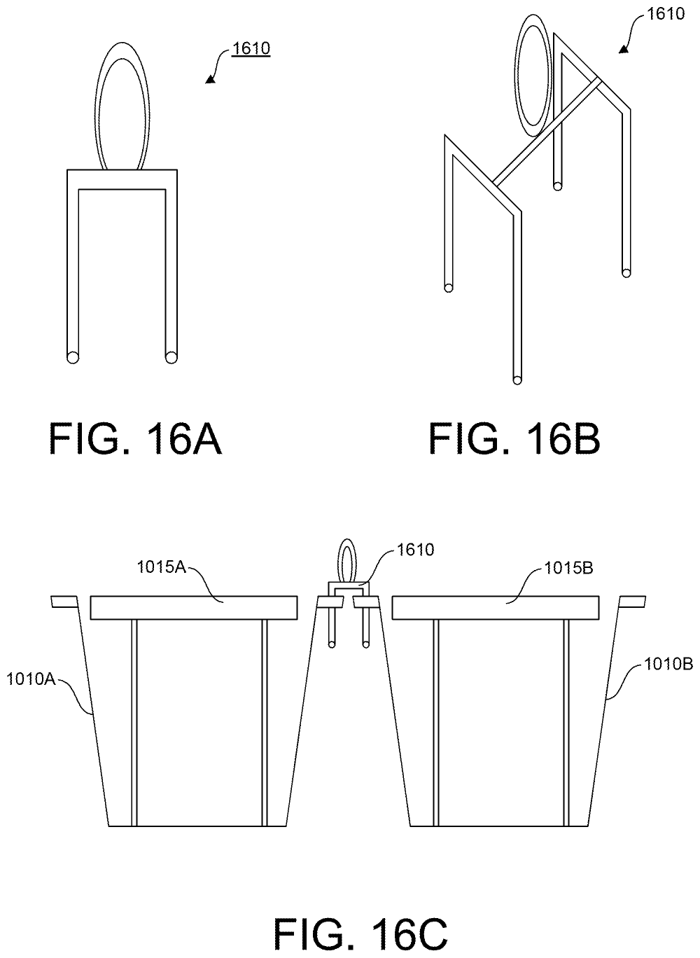

FIG. 16A is an illustration of a side view of an example locking device 1610 for use with the grow tray system 1000. FIG. 16B is an illustration of a perspective view of an example locking device 1610 for use with the grow tray system 1000. FIG. 16C is an illustration an example locking device 1610 connecting a pair of grow trays 1010 (i.e., the grow trays 1010A and 1010B) including inserts 1015 (i.e., inserts 1015A and 1015B). The locking device 1610 may have four pins that are adapted to fit in corresponding slots in the grow trays 1010. When the locking device 1610 is attached between two grow trays 1010, the grow trays 1010 are effectively locked together until the locking device 1610 is removed. As shown in FIGS. 16A-C, the locking device 1610 may include a ring or loop that may be used to make removing the locking device 1610 easier.

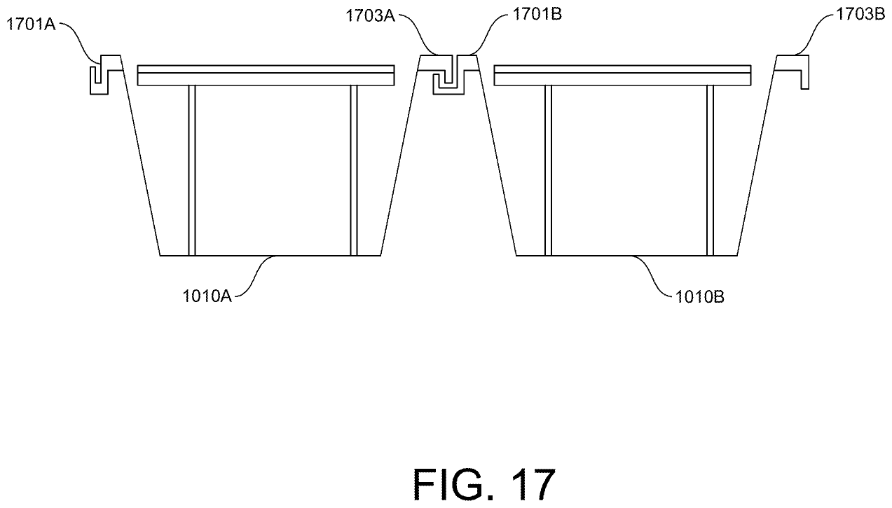

FIG. 17 is an illustration of example grow trays 1010 with locking components. In the example shown, each tray 1010 (i.e., trays 1010A and 1010B) includes both a male locking component 1703 (i.e., 1703A and 1703B) and a female locking component 1701 (i.e., 1701A and 1701B). When two trays 1010 are placed adjacent to one another, the male locking component 1703 of the first tray 1010 may be received by the female locking component 1701 of the second tray 1010, effectively locking the two trays 1010 together. By locking the trays 1010 to each other, the overall stability of the grow trays 1010 when placed on a rack or conveyance means is increased.

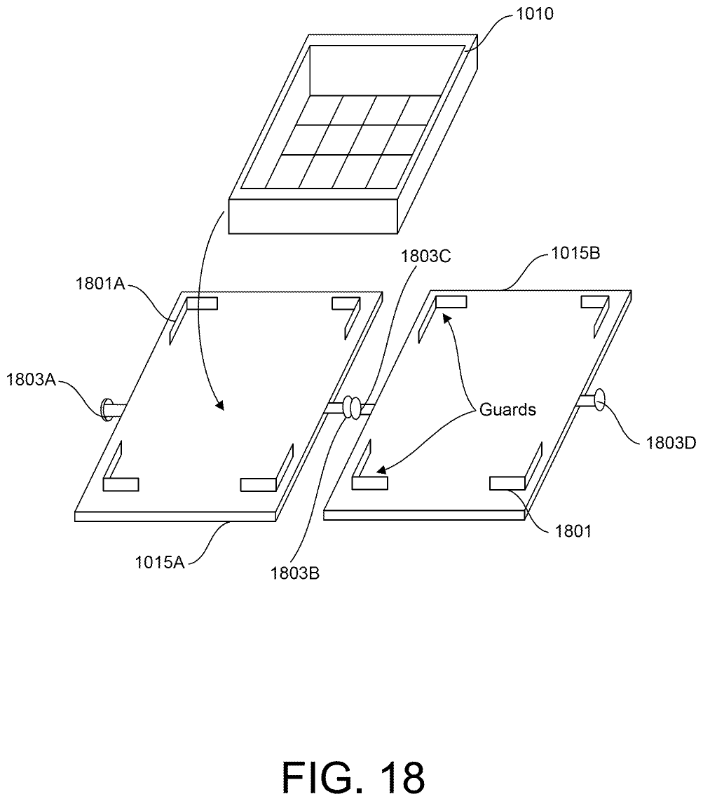

FIG. 18 is an illustration of an example grow tray system 1000 that includes an insert 1015 with safety guards 1801. As shown, instead of legs 1105, each insert 1015 (i.e., the inserts 1015A and 1015B) includes four safety guards 1801. The safety guards 1801 may be sized to ensure that a minimum amount of space exists between the bottom of the insert 1015 and the grow tray 1010 when the insert 1015 is placed in the grow tray 1010. In addition, each insert 1015 include a locking component 1803 (i.e., the locking components 1803A-D) that may lock or connect with a locking component 1803 of an insert 1015 in an adjacent tray 1010.

### III. Oxygenation System

FIG. 19 is an illustration of an example tank 1900 for oxygenating water with or without a nutrient solution. The tank 1900 may be constructed from PVC. The tank 1900 may be approximately 10-15 gallons. However, other sized tanks may be used.

The tank 1900 may include an inlet 1910 that receives water with or without a nutrient solution from a return tank of a reservoir system. The inlet 1910 may be approximately 1-2 inches in diameter. Other sizes may be used. Depending on the embodiment, the inlet 1910 may receive the water with or without a nutrient solution at a rate of approximately 30-50 gallons per minute. The water with or without a nutrient solution received from the return tank may have passed through one or more grow beds associated with the reservoir system and may be depleted of one or more elements and nutrients including oxygen.

The water with or without a nutrient solution entering the tank 1900 through the inlet 1910 may fill some or all of what is referred to as a first chamber 1920 of the tank 1900. The first chamber 1920 of the tank 1900 may be approximately ⅓ of the total oxygenation tank. The first chamber 1920 may be separated from a second chamber 130 of the tank 1900 by a membrane 105. The membrane 105 may include a plurality of perforations that allow the water with or without a nutrient solution to drain from the first chamber 120 into the second chamber 130 via gravity. Depending on the embodiment, the membrane 105 may be constructed from 3-5 holes, it is made out of PVC ½″-1″ wide. The second chamber is ⅔ of the tank.

The tank 1900 may further include an oxygen inlet 1903 and an oxygen outlet 1915. The oxygen inlet 1903 may receive oxygen (or other gasses) from an oxygen source such as an oxygen generator. Other sources of oxygen may be used. The inlet 1903 may be approximately ½″-1″ and may receive oxygen at a rate of approximately 1-5 liters per minute. The outlet 115 may be approximately ½″-1″ and may connect to a vent. Other sized inlets 1903 and outlets 1915 may be used.

In some embodiments, the inlet 1903 and the outlet 1915 may be placed at approximately the same height on opposite walls of the second chamber 1930. Alternatively, the outlet 1915 may be placed higher than the inlet 1903.

When the gas inlet 1903 receives oxygen, and the gas outlet 1915 is opened, the oxygen may collect towards the top of the second chamber 1930, forming what is referred to herein as the oxygen pocket 1925. When the water with or without a nutrient solution passes through the membrane 1905 and into the second chamber 1930, the drops of the water with or without a nutrient solution pass through the oxygen pocket 1925 by force of gravity. The drops of the water with or without a nutrient solution passing through the oxygen pocket 1925 are uniformly oxygenated as oxygen from the oxygen pocket 1925 dissolves in each drop. Because each drop of the water with or without a nutrient solution passes through the oxygen pocket 1925, the water with or without a nutrient solution is oxygenated with a much greater uniformity and concentration than is possible with conventional air stone based oxygenation systems.

After the water with or without a nutrient solution is oxygenated, it may be pumped out of the second chamber 1930 through an outlet 1935 to a reservoir. The outlet 1935 may be approximately 1-2 inches in diameter and the water with or without a nutrient solution may be pumped from the second chamber 1930 at a rate of approximately 30-50 gallons per minute. Other sized outlets 1935 may be used.

FIG. 20 is an illustration of an example hydroponic grow system 2000 that incorporates the oxygenating tank 1900 of FIG. 19. The tank 1900 receives oxygen from an oxygen generator 2005. In the example shown, the oxygen generator 2005 is capable of generating approximately 1-5 liters per minute of oxygen. A suitable generator 2005 is the AirSep™ PSA Oxygen generator. Other oxygen generators may be used.

The tank 1900 receives water with or without a nutrient solution from a reservoir tank 2020 that is part of the reservoir system that provides water with or without a nutrient solution to a plurality of grow beds 2030. Any nutrients are added to the reservoir 2020. More or fewer grow beds 2030 may supported. Each grow bed 2030 may include a substrate that absorbs the water with or without a nutrient solution in the grow bed 2030 and provides the solution to a one or more plants growing in the substrate. Depending on the embodiment, multiple reservoir tanks 2020 may be used to provide nutrient solution to multiple sets of grow beds 2030.

The water with or without a nutrient solution is pumped into the tank 1900 from the reservoir tank 2020 by a pump P3 at a rate of approximately 30-50 gallons per minute through the inlet 1910. A suitable pump P3 is the Oxyflow® supply pump. Other pumps may be used.

The water with or without a nutrient solution is oxygenated in the tank 1900 as described above and the oxygenated nutrient solution is returned to the reservoir tank 2020 via the outlet 1935. In some embodiments, the water with or without a nutrient solution may have a concentration of oxygen that is between 10 ppm and 30 ppm after leaving the tank 1900. However, a greater or lower concentration may be used depending on the number of grow beds 2030 that are supported by the grow system 2000.

The oxygenated water with or without a nutrient solution is pumped from the reservoir tank 2020 to the grow beds 2030 by a pump P1. The oxygenated nutrient solution may be pumped at a rate of approximately 6 gallons per minute. A suitable pump P1 is the TACO® circulator pump. Other pumps may be used.

As shown, the oxygenated water with or without a nutrient solution may pass through each grow bed 2030 in sequence before reaching the return tank 2040. For example, the oxygenated water with or without a nutrient solution may first be received by the grow bed 2030A, may flow from the grow bed 2030A to the grow bed 2030B, may flow from the grow bed 2030B to the grow bed 2030C, and may flow from the grow bed 2030C to the grow bed 2030D, and from there into the return tank 2040.

As may be appreciated, as the oxygenated nutrient solution flows from grow bed 2030 to grow bed 2030, the plants in each grow bed 2030 absorb some of the oxygen from the water with or without a nutrient solution. Because the tank 1900 described herein allows for a much greater concentration of oxygen in the oxygenated nutrient solution, the number of grow beds 2030 (and plants) that can be supported by a single reservoir tank 2020 is greatly increased when compared with prior art oxygenation systems.

Once the depleted nutrient solution fills the return tank 2040 to predetermined level, a pump P2 may be activated to pump the water with or without a nutrient solution back to the reservoir 2020 where it may be recirculated to the grow beds 2030 and/or reoxygenated by the tank 1900 as described above. The depleted nutrient solution may be pumped at a rate of at least once an hour. A suitable pump P2 is the TACO® circulator pump. Other pumps may be used.

In some embodiments, the return tank 2040 may include a sensor 2050 that measures the oxygen concentration of the water with or without a nutrient solution in the return tank 2040. If the concentration of oxygen is below a threshold concentration, for example 10 ppm, then the sensor 2050 may activate the oxygen generator 2005 and/or the pump P3 to cause the water with or without a nutrient solution to be reoxygenated in the tank 1900 as described above.

### IV. Nutrient Solution

A nutrient solution for hydroponically growing plants such as hemp is provided. The nutrient solution includes water and plurality of major nutrients including, but not limited to, nitrate, ammonium, phosphorus, calcium, and magnesium. The nutrient solution may include a plurality of minor nutrients such as iron, manganese, boron, copper, zinc, molybdenum, sodium, nickel, aluminum, silicon, and sulfur.

With respect to the major nutrients, in one embodiment, the concentration of nitrate in the solution may be between 8.5 and 43 parts per million (ppm). An example nitrate concentration is 17 ppm. The concentration of ammonium in the solution may be between 0.6 and 10 ppm. An example ammonium concentration is 1.2 ppm. The concentration of phosphorus in the solution may be between 2.6 and 13 ppm. An example phosphorus concentration is 5.2 ppm. The concentration of potassium in the solution may be between 13.3 and 66.5 ppm. An example potassium concentration is 26.6 ppm. The concentration of calcium in the solution may be between 8.4 and 42 ppm. An example calcium concentration is 16.8 ppm. The concentration of magnesium in the solution may be between 4.4 and 22 ppm. An example magnesium concentration is 8.8 ppm.

With respect to the minor nutrients, in one embodiment, the concentration of iron in the solution may be between 0.16 and 0.8 parts ppm. An example iron concentration is 0.32 ppm. The concentration of manganese in the solution may be between 0.07 and 0.35 ppm. An example manganese concentration is 0.14 ppm. The concentration of boron in the solution may be between 0.07 and 0.35 ppm. An example boron concentration is 0.14 ppm. The concentration of copper in the solution may be between 0.019 and 0.095 ppm. An example copper concentration is 0.038 ppm. The concentration of zinc in the solution may be between 0.02 and 0.1 ppm. An example zinc concentration is 0.04 ppm. The concentration of molybdenum in the solution may be between 0.003 and 0.015 ppm. An example molybdenum concentration is 0.006 ppm. The concentration of sodium in the solution may be between 1.15 and 5.75 ppm. An example sodium concentration is 2.3 ppm. The concentration of nickel in the solution may be between 0.003 and 0.015 ppm. An example nickel concentration is 0.006 ppm. The concentration of aluminum in the solution may be between 0.0025 and 0.0125 ppm. An example aluminum concentration is 0.005 ppm. The concentration of silicon in the solution may be between 0.038 and 0.19 ppm. An example silicon concentration is 0.077 ppm. The concentration of sulfur in the solution may be between 14.7 and 73.5 ppm. An example sulfur concentration is 29.4 ppm.

Depending on the embodiment, the solution may have a conductivity of between 1 and 3 mmho/cm. An example conductivity is 2.06 mmho/cm. The solution may have a pH of between 5 and 8. An example pH is 5.83.

In some implementations, the nutrient solution as described above may be created by combining approximately 16 ounces of tomato mix fertilizer with approximately 38 grams of potassium nitrate. Approximately 458 grams of magnesium sulfate may be added to the solution in addition to approximately 542 grams of calcium nitrate. Finally, approximately 2000 ounces of a microbe solution may be added to the nutrient solution. Examples of suitable microbe solutions include SOS Beneficial Bacteria Super Organic Stimulator and Mammoth™ Mighty Microbes. Other materials and/or solutions may be added to the nutrient solution. Sufficient water may be added to the nutrient solution to achieve the chemical concentrations and solution properties described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A hydroponic grow system comprising:
a first plurality of trays, wherein each tray of the first plurality of trays comprises an inlet port and an outlet port;
a second plurality of trays, wherein each tray of the second plurality of trays comprises an inlet port and an outlet port; and
a water component that provides a nutrient solution to the trays of the first plurality of trays through the inlet ports of the trays of the first plurality of trays, and wherein the trays of the first plurality of trays provide the nutrient solution to the trays of the second plurality of trays from the outlet ports of the trays of the first plurality of trays to the inlet ports of the trays of the second plurality of trays.

2. The system of claim 1, further comprising a lighting component that provides between 200 and 1300 μmoles per Watt.

3. The system of claim 1, further comprising a rack component that stores the first plurality of trays on a top level and the second plurality of trays on a bottom level with additional levels based upon a cultivar.

4. The system of claim 1, further comprising a climate component that keeps a leaf temperature of a plurality of plants growing in the trays of the first plurality of trays and the second plurality of trays between 65 and 75 degrees Fahrenheit.

5. The system of claim 1, further comprising a humidity component that keeps a humidity of the system between 50% and 70% humidity.

6. The system of claim 1, further comprising a CO₂ component that keeps a CO₂ concentration of system between 800 and 1500 ppm.

7. The system of claim 1, further comprising a conveyor component.

8. The system of claim 1, wherein the water component comprises a reservoir, a reverse osmosis filter, an oxygenation system, and a chiller.

9. The system of claim 1, wherein the water component provides the nutrient solution to the trays of the first plurality of trays through the inlet ports of the trays of the first plurality of trays using removable connectors between the water component and each of the inlet ports of the trays of the first plurality of trays.

10. The system of claim 9, wherein the removable connectors comprise Banjo connectors and unions.

11. The system of claim 1, further comprising a security component.

12. The system of claim 1, further comprising a trimming component.

13. The system of claim 1, further comprising a curing component.

14. The system of claim 1, further comprising a packing and shipping component.

15. The system of claim 1, further comprising a rack component that stores the first plurality of trays on a top level and the second plurality of trays on a bottom level, wherein the rack component further includes one or more removeable or adjustable sides that allow the first or second plurality of trays to be placed on a conveyor system.

16. A grow tray system comprising:
a grow tray adapted to hold a nutrient solution; and
an insert that rests in the grow tray, wherein the insert comprises:
a top surface;
a bottom surface;
a plurality of legs that extend from the bottom surface of the insert towards the grow tray such that when the grow tray holds the nutrient solution a space is formed between a surface of the nutrient solution and the bottom surface of the insert; and
a plurality of openings that extend through the top surface and the bottom surface, wherein each opening is adapted to receive a growth medium such that a first portion of the growth medium is in contact with the nutrient solution while a second portion of the growth medium is in contact with air through the space formed between the surface of the nutrient solution and the bottom surface of the insert.

17. The system of claim 16, wherein the grow tray system further includes a scrog structure.

18. A tank for oxygenating a solution comprising:
a first chamber;
a second chamber below the first chamber; and
a membrane connecting the first and second chamber, wherein the first chamber receives water with or without a nutrient solution and the second chamber receives oxygen.

19. The tank of claim 18, wherein the second chamber receives oxygen from an oxygen generator.

20. The tank of claim 18, wherein the water with or without a nutrient solution in the first chamber passes through the membrane into the second chamber.
